(19) United States
(12) Patent Application Publication
(10) Pub. No.: US 2026/0097547 A1
(43) Pub. Date: Apr. 9, 2026

(54) MACHINE ELEMENT FOR MOUNTING A MOLD AS WELL AS A TIE-BAR-LESS MOLDING MACHINE HAVNG SUCH A MACHINE COMPONENT

(71) Applicant: ENGEL AUSTRIA GmbH, Schwertberg (AT)

(72) Inventors: Christoph BALKA-HINTERSTEINER, Schwertberg (AT); Gerhard HACKL-LEHNER, St. Thomas/BI (AT); Klaus Maximilian RIEGLER, Grein (AT); Johannes Leonhard KRONDORFER, Linz (AT)

(21) Appl. No.: 19/348,076

(22) Filed: Oct. 2, 2025

(30) Foreign Application Priority Data
Oct. 3, 2024 (AT) A 50801/2024

(51) Int. Cl. B29C 45/67; B29C 33/20; B29C 45/76

(52) U.S. Cl. CPC B29C 45/67; B29C 33/202; B29C 45/7653; B29C 2945/76498; B29C 2945/76709; B29C 2945/76869

(57) ABSTRACT

A machine element for mounting a mold, in particular a mold mounting plate, for a tie-bar-less closing unit of a molding machine includes a plate-shaped base body and at least two pressure pad elements respectively designed as part of a hydraulic actuator, preferably a pressure pad, and have a longitudinal axis. The at least two pressure pad elements are offset transversely from one another with respect to at least one of the longitudinal axes, and for the at least two pressure pad elements at least one respective strut is provided, the strut connecting the respective pressure pad element to the base body.

### BACKGROUND OF THE INVENTION

The present disclosure relates to a machine element for mounting a mold, in particular a mold mounting plate, for a tie-bar-less closing unit of a molding machine, as well as a tie-bar-less molding machine having such a machine component.

Molding machines can include injection molding machines, injection presses, presses and the like. Molding machines in which the plasticized molding mass is fed into an open mold are also quite conceivable.

The following prior art is outlined using an injection molding machine, the same applies in general to molding machines.

Generic machine elements for mounting a mold, in particular mold mounting plates, for tie-bar-less injection molding machines, comprise a plate-shaped base body and at least two pressure pad elements, each of which is designed as part of a hydraulic actuator, preferably a pressure pad, and has a longitudinal axis. Tie-bar-less or so-called column-less closing units have a machine frame which is designed to absorb closing forces. This machine frame is often C-shaped. When applying the closing force, the problem is that the machine frame deforms due to the high closing forces, with C-shaped machine frames in particular usually expanding. If the machine frame is widened accordingly, this will result in an undesirable tilting of the fixed and movable mold mounting plates relative to each other.

Particularly in the case of the movable mold mounting plate, this leads to the problem that the tilting movement causes bending stress on the machine components adjacent to the movable mold mounting plate, which exert the closing force on the movable mold mounting plate. In most cases, the pressure pads of a closing force mechanism are directly connected to the movable mold mounting plate, wherein the pressure pad housing is usually screwed, welded or formed in one piece with the movable mold clamping plate, wherein in the event of tilting, through tilting, bending stress is transferred directly via the pressure pad to one of the piston rods or push rods acting on it.

Since the piston rods or push rods naturally counteract any corresponding bending, this further increases the effect of the mold mounting plates tilting towards each other. Such tilting in turn directly influences the quality of the injection-molded components to be produced. This bending stress must be counteracted by appropriate design of the components.

The disadvantage is not only the ecological aspect, but also the economic aspect, wherein a high material expenditure and high production energy must be invested for providing sufficiently rigid and stable machine elements for mounting a mold, which can also withstand the resulting forces with as little deformation as possible.

### SUMMARY OF THE INVENTION

The object of the present invention is to provide a machine component for mounting a mold, as well as a molding machine with such a machine component, which at least partially improve the disadvantages of the prior art described above and/or which withstands the use of a tie-bar-less closing unit with lower material expenditure and/or with which the manufacturing expenditure for production can be reduced and/or with which fewer deformation movements are exerted on the mold during operation.

This object is achieved in the context of the present disclosure by a machine element for mounting a mold, in particular a mold mounting plate, for a tie-bar-less closing unit of a molding machine, as well as a molding machine having such a machine element.

According to an exemplary embodiment of the present disclosure, a machine element for mounting a mold, in particular a mold mounting plate, for a tie-bar-less closing unit of a molding machine, comprises a plate-shaped base body and at least two pressure pad elements, which are each designed as part of a hydraulic actuator, preferably a pressure pad, and have a longitudinal axis, wherein:
the at least two pressure pad elements are transversely offset to each other at least in relation to at least one of the longitudinal axes, and
for the at least two pressure pad elements at least one respective strut is provided, which connects the respective pressure pad element to the base body.

By decoupling the at least two pressure pad elements from each other, as well as from the base body of the machine element via at least one strut in each case, deformation introduced into the machine component via the base body can be decoupled from the pressure pad element in an optimal manner, so that this deformation can essentially be reduced to a large extent via a deformation of the struts and the pressure pad elements can be protected.

By means of an appropriate design, the expected load on the pressure pad element and the elements of the closing unit cooperating with the pressure pad element (such as the piston rod, the push rod and the closing mechanism) can be significantly reduced.

In the context of this document, when a plate is mentioned, it does not necessarily mean a flat, planar plate. The plate can also have recesses, elevations and a concave or convex machining of the mounting surface for optimal closing force distribution when in the closed state. Designs with ribs, webs, in particular connecting webs with pressure pads, or other structures for stabilization or deformation optimization are also conceivable.

Molding machines can include injection molding machines, injection presses, presses and the like. Molding machines in which the plasticized molding mass is fed into an open mold are also quite conceivable.

Preferably, the machine element for mounting a mold for a tie-bar-less closing unit is designed as a mold mounting plate, particularly preferably a movable mold mounting plate. In other words, the at least one strut that connects a respective pressure pad element to the base body can also be regarded as a connecting web.

At least two, preferably all, of the following can be designed in one piece, preferably as a cast part:
the plate-shaped base body,
the at least one strut, and
at least two pressure pad elements.

Preferably, the plate-shaped base body, at least one strut, and the at least two pressure pads, are or were manufactured in one piece by a casting process, in particular a steel casting process.

The at least one strut can have a strut longitudinal axis and a first point at which the strut longitudinal axis meets the base body is different from a second point at which the longitudinal axis of the corresponding pressure pad element meets the base body.

In other words, the strut can be designed with its strut longitudinal axis offset from a longitudinal axis of the corresponding pressure pad element, whereby a force introduction can be adapted by a correspondingly selected deformation of the at least one strut in the base body and/or the closing unit of the forming machine.

An imaginary offset axis can exist between the at least two pressure pad elements and the first point has a strut point offset relative to the second point along the offset axis.

Preferably, the strut point offset in the at least two pressure pad elements points in the same direction.

At least two respective struts can be provided per pressure pad element, and preferably the respective at least two struts form an angle with each other.

Preferably, the angle enclosed by the at least two struts provided for a pressure pad element lies in a range of 20 to 40 degrees, particularly preferably 25 to 35 degrees.

The at least two pressure pad elements can be designed at least as part of a hydraulic piston-cylinder unit, preferably as a pressure pad housing and/or cylinder.

The pressure pad elements can be formed, for example, in one piece with the at least one strut and the base body during production (for example by a casting process), wherein the pressure pad elements are machined in a subsequent machining process such that they represent the cylinder for receiving a piston to form a hydraulic piston-cylinder unit.

At least two pressure pad housings can have a different inner diameter.

During operation of the closing unit, corresponding deformations and loads occur in the mounting region of a mold, especially in a mold mounting plate. In particular, these differing loads along the mounting region are amplified in tie-bar-less closing units, preferably with C-frames, since the elastic deformation of the frame causes the mold to open on one side when the closing force is introduced. This phenomenon of one-sided openings can be counteracted by applying an asymmetric force to the mold. Such asymmetric force introduction can be optimized in that, when multiple pressure pads are provided, these pressure pads also introduce different forces. This can be implemented, for example, by designing the pressure pads with different diameters and applying the same hydraulic pressure, which results in different pressure forces being introduced due to the different effective areas.

The struts can be asymmetrical when viewed transversely to the longitudinal axis, preferably wherein a first contour of the struts is substantially straight and/or a second contour of the struts is curved. A curvature of the second contour can, for example, be elliptical.

The asymmetric design of the struts allows, in a further advantageous manner, an elastic deformation or a force transmission to be directed into the machine element in order to protect surrounding components from deformation.

At least two guide shoes can be provided which are offset from each other along the longitudinal axis.

Furthermore, protection is sought for a tie-bar-less molding machine, in particular an injection molding machine, having a machine element according to the present disclosure.

The molding machine can have a control or regulation unit designed to control the hydraulic actuators associated with the at least two pressure pad elements in order to apply different forces on the machine element, in particular by applying different hydraulic pressures.

At least two push rods can be provided which can be locked relative to a machine frame and interact with the hydraulic actuators.

The at least two push rods can have different diameters, preferably wherein the push rod further away from the frame has a smaller or a larger diameter (depending on the tension to be expected in the respective push rod).

As already explained, when a closing force is applied to a closing unit, especially in tie-bar-less molding machines, different force relations arise, which means that even when multiple push rods are provided, the push rods can be adapted to the individual force relations. For example, a push rod that is subject to lower loads can be implemented with a smaller diameter, which has an impact on both the ecological and economic aspects of the closing unit.

Preferably, the at least two push rods—with the exception of the attachment to the hydraulic actuators—are released from the rest of the forming machine. In other words, the at least two push rods are only connected to the forming machine in an unlocked state via the hydraulic actuators and thus “hang freely” on the hydraulic actuators.

At least two guides can be provided which are preferably offset from one another along the longitudinal axis, wherein the guides are designed such that it is possible to lift the machine frame from a guide rail.

Such lifting of the machine element (in particular the mold mounting plate) is in turn due to the loads acting on the closing unit during the closing force build-up, wherein the front part of the machine element, on which the mold or the molding tool is arranged, distances itself from the machine frame during the closing force build-up due to the elastic deformation of the machine frame. Since the guides or guide rails are usually arranged on the frame, the machine element is lifted from the guide rail.

Advantageously, such a lifting is permitted by the guide in order, on the one hand, to prevent damage to the guide by the lifting and, on the other hand, to ensure that the machine element is secured in position relative to the guide and the guide rail (and thus the frame).

### BRIEF DESCRIPTION OF THE DRAWINGS

Further details and advantages of the present invention will be explained in more detail below with reference to the drawings, in which:

FIG. 1 shows a first exemplary embodiment of a closing unit in a perspective view,

FIG. 2 shows the exemplary embodiment of FIG. 1 in a further perspective view,

FIG. 3 shows the fast-stroke device from FIGS. 1 and 2 in isolation,

FIG. 4 shows a second exemplary embodiment of a closing unit,

FIG. 5 shows a third exemplary embodiment of a closing unit,

FIG. 6 shows another exemplary embodiment of a mold mounting plate,

FIG. 7 shows the exemplary embodiment of FIG. 6 in a sectional view,

FIG. 8 shows the mold mounting plate from FIGS. 6 and 7 in isolation,

FIG. 9 shows the mold mounting plate from FIGS. 6 to 9 in a further perspective view in isolation,

FIG. 10 shows the mold mounting plate from FIGS. 6 to 9 in a plan view,

FIG. 11 shows section A-A marked in FIG. 10,

FIG. 12 shows section B-B marked in FIG. 10, and

FIG. 13 shows a further exemplary embodiment of a closing unit.

### DETAILED DESCRIPTION OF THE INVENTION

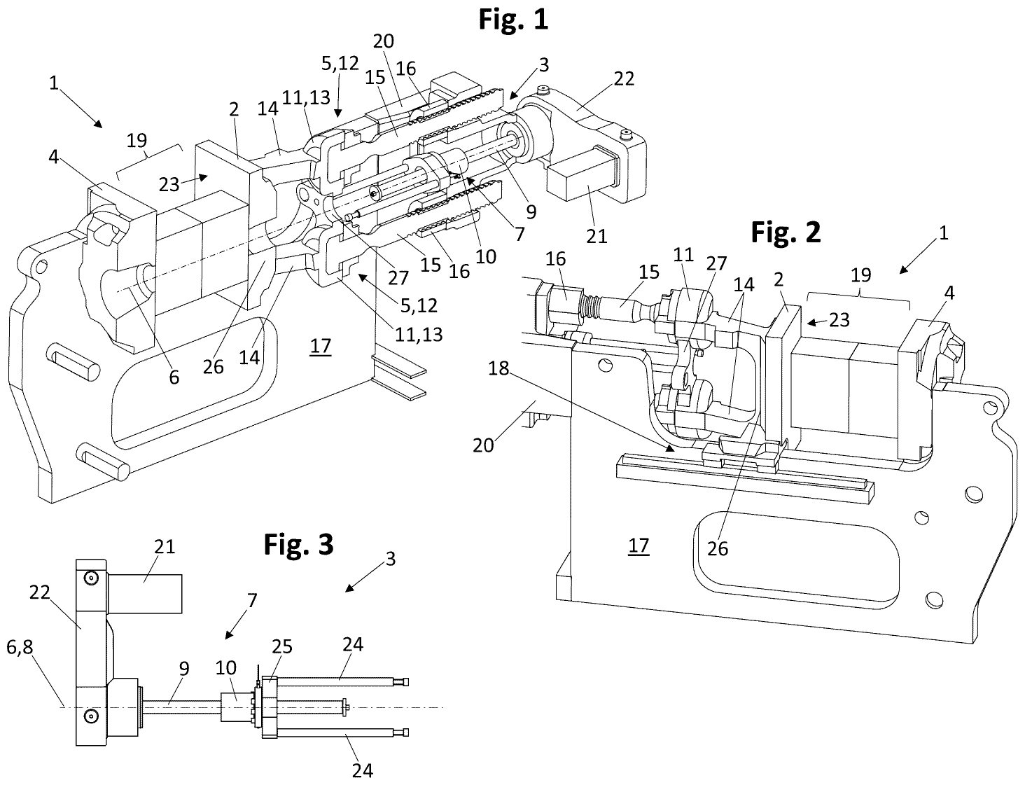

FIGS. 1 and 2 show a first exemplary embodiment of a closing unit 1 in different perspective views. In the views of FIGS. 1 and 2, the closing unit 1 has been cut through a vertical plane spanned by the central longitudinal axis 6 to improve visibility.

It can be seen that the closing unit 1 has a machine frame 17. On this machine frame 17, on the one hand, the fixed mold mounting plate 4 is mounted, and on the other hand, the movable mold mounting plate 2 is mounted via the sliding guides 18. The movable mold mounting plate 2 is mounted displaceably relative to the fixed mold mounting plate 4 parallel to the central longitudinal axis 6. The sliding guides 18 of the movable mold mounting plate 2 are implemented by a sliding rail—which is mounted on the machine frame 17—and sliding shoes guided thereon (which are connected to the movable mold mounting plate 2).

A mold 19 is mounted between the movable mold mounting plate 2 and the fixed mold mounting plate 4, wherein a mold half of the mold 19 is arranged on each one of the mounting surfaces 23 of the fixed mold mounting plate 4 and the movable mold mounting plate 2. Furthermore, the closing unit 1 comprises a fast-stroke device 3, which is designed to displace the movable mold mounting plate 2 relative to the fixed mold mounting plate 4. In this exemplary embodiment, this fast-stroke device 3 is implemented by a spindle drive 7.

For a more detailed explanation of the fast-stroke device 3, reference is made to FIG. 3, which shows the fast-stroke device 3 in isolation. The fast-stroke device 3 comprises a central spindle drive 7, which comprises a spindle 9 and a recirculating ball nut 10 cooperating therewith. The spindle 9 can be driven about the rotation axis 8 by means of an electric drive unit 21 and a gear 22. Alternatively, versions with a hydraulic or pneumatic drive unit are also conceivable. Due to the rotational movement of the spindle 9 around the rotation axis 8, the recirculating ball nut 10 on the spindle 9 can be driven translationally along the rotation axis 8.

The recirculating ball nut 10 is rigidly connected to the link bridge 25 by means of a screw connection, wherein the link bridge 25 is in turn rigidly connected to the two link rods 24. The link rods 24 are in turn—as can be seen from FIGS. 1 and 2—connected to the movable mold mounting plate 2, whereby a displacement of the recirculating ball nut 10 along the central longitudinal axis 6 can be transferred directly to the movable mold mounting plate 2 via the rotational movement of the spindle 9 about the rotation axis 8. The rotation axis 8 of the spindle 9 and/or the spindle drive 7 is concentric to the central longitudinal axis 6. The spindle drive 7 is supported via the support plate 20 on the machine frame 17 of the closing unit 1.

In this embodiment, the support plate 20 is screwed to the machine frame.

By means of this fast-stroke device 3, the movable mold mounting plate 2 can be lifted from the fixed mold mounting plate 4, for example in order to release a produced molded part for removal or to insert an insert into the mold 19. The movable mold mounting plate 2 can then be moved closer to the fixed mold mounting plate 4 via the fast-stroke device 3 until the mold halves of the mold 19 close.

After closing the mold 19, a closing force is exerted on the mold 19 between the fixed mold mounting plate 4 and the movable mold mounting plate 2 via the closing force mechanism 5, which is formed separately from the fast-stroke device 3.

In this exemplary embodiment of FIGS. 1 and 2, the closing force mechanism 5 comprises four pressure pads 11, wherein only two pressure pads 11 are visible in FIGS. 1 and 2 due to the sectional view. These pressure pads 11 are implemented as hydraulic piston-cylinder units 12, wherein the cylinder of these piston-cylinder units 12 of the pressure pads 11 is formed integrally with the movable mold mounting plate 2.

In this embodiment, the cylinders 13 of the pressure pads 11 are connected to each other via the yoke 27, with the linkage rods 24 of the fast-stroke device 3 being connected to this connection. The cylinders 13 of the pressure pads 11 are further connected via the strut 14 to the base body 26 of the movable mold mounting plate 2 forming the mounting surface 23.

This design of the movable mold mounting plate 2 with the strut 14 allows a certain elastic deformability, which makes it possible to implement plate parallelism between the movable mold mounting plate 2 and the fixed mold mounting plate 4 even in the case of an asymmetrical closing force due to an asymmetrically arranged mold 14 or an asymmetrical pressure distribution.

The pistons of the piston-cylinder units 12 of the pressure pads 11 are represented by the push rods 15. These push rods 15 can be connected to the support plate 20 and thus to the machine frame 17 via split locking nuts 16. When the mold 19 is now closed via the fast-stroke device 3, the push rods 15 are locked to the support plate 20 and thus to the machine frame 17 via the split locking nuts 16. After locking the push rods 15, a pressure is built up in the pressure pads 11—more precisely: the piston-cylinder units—which exerts a compressive force—more precisely: a closing force—between the movable mold mounting plate 2 and the fixed mold mounting plate 4 on the mold 19 via the strut 14.

A design of the movable mold mounting plate 2 with pressure pads 11 spaced apart by the strut 14 further provides the advantage that a free space is created between the connecting struts 14, which is suitable for accommodating an ejector mechanism (which is not shown in the figures for reasons of clarity).

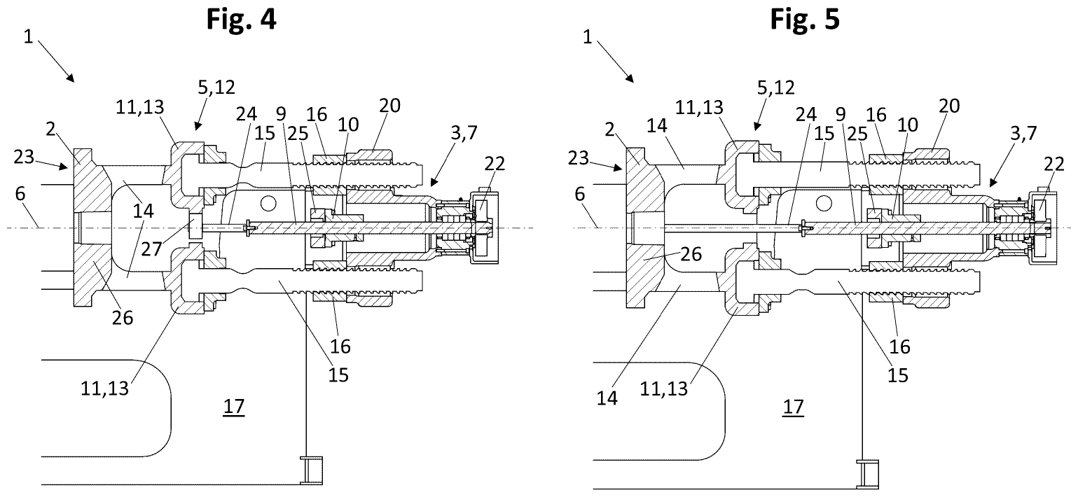

FIG. 4 shows a further exemplary embodiment of a closing unit 1, which is similar to the embodiment of FIGS. 1 and 2 on a larger scale. In the exemplary embodiment of FIG. 4 of the closing unit 1, however, the pressure pads 11 are not connected to each other, but are merely mounted against each other via the strut 14 of the movable mold mounting plate 2.

A yoke 27 is formed on one of the pressure pads 11, which yoke 27 extends in the direction of the central longitudinal axis 6. The fast-stroke device 3 is connected to this yoke 27 via the link rod 24.

FIG. 5, on the other hand, shows an embodiment of a closing unit 1 in which the pressure pads 11 are completely decoupled from each other and are only connected to each other via the strut 14 and the movable mold mounting plate 2. In this exemplary embodiment, the fast-stroke device 3 is connected via the link rod 24 to a front base body 26 of the movable mold mounting plate 2, which front base body 26 forms the mounting surface 23. The link rod 24 is connected to a side of the base body 26 of the movable mold mounting plate 2 facing away from the mounting surface 23.

The remaining features of the exemplary embodiments of FIGS. 4 and 5 essentially correspond to those of the exemplary embodiment of FIGS. 1 and 2.

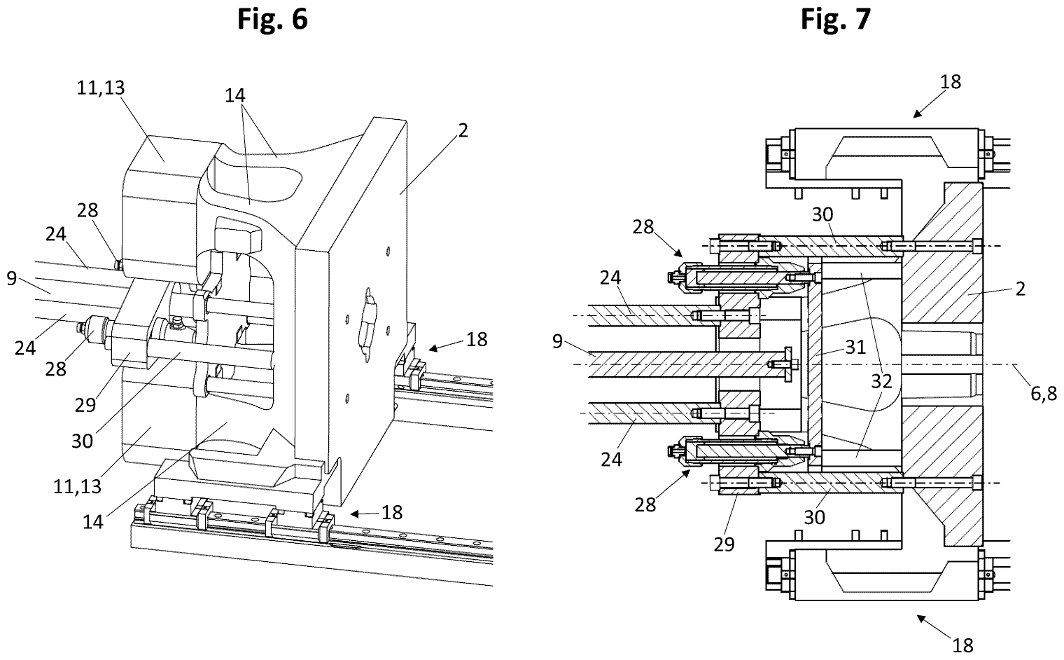

FIG. 6 shows a further exemplary embodiment of a movable mold mounting plate 2 designed as a machine element. The exemplary embodiment shown in FIG. 6 is shown in a sectional view in FIG. 7. In this exemplary embodiment of FIGS. 6 and 7, the link rods 24 of the fast-stroke device 3 known from the previous figures are attached to an additional fast-stroke element 29. Strictly speaking, the link rods 24 are rigidly connected to the fast-stroke element 29 via a screw connection, whereby the translational movement of the fast-stroke device 3 or of the spindle drive 7 is transmitted directly to the fast-stroke element 29.

The fast-stroke element 29 is screwed to the movable mold mounting plate 2 by means of the connecting rods 30, whereby this fast-stroke movement is passed on to the movable mold mounting plate 2. By providing this fast-stroke element 29, a construction space can be created centrally behind the movable mold mounting plate 2, which in this exemplary embodiment serves to accommodate the ejector drive 28.

The ejector columns 32 serve to eject a formed workpiece from the mold after forming. In order to carry out this ejection movement, it is necessary to drive the ejector columns 32 linearly along their longitudinal axis. This linear movement of the ejector columns 32 attached to the ejector plate 31 is implemented by the ejector drives 28 designed as a hydraulic piston-cylinder unit. These ejector drives 28 are supported by the cylinders of the piston-cylinder units on the fast-stroke element 29.

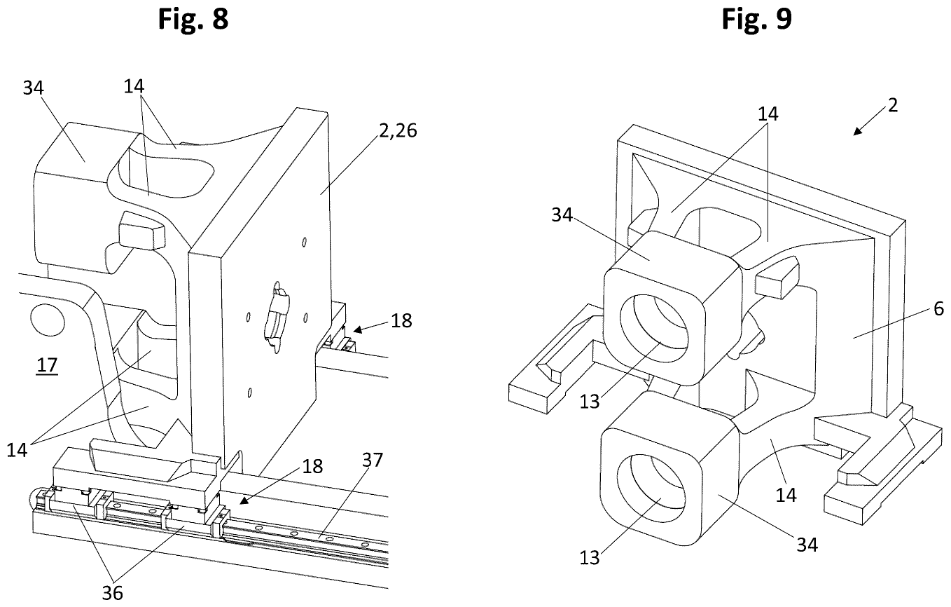

Furthermore, the movable mold mounting plate 2 of this exemplary embodiment is implemented as a machine element, with the precise properties of this machine element or of the movable mold mounting plate 2 being discussed with reference to FIGS. 8 to 12.

FIG. 8 shows the movable mold mounting plate 2 in a perspective view in isolation on the machine frame 17.

FIG. 9 shows a further perspective view of this exemplary embodiment of the movable mold mounting plate 2 in isolation.

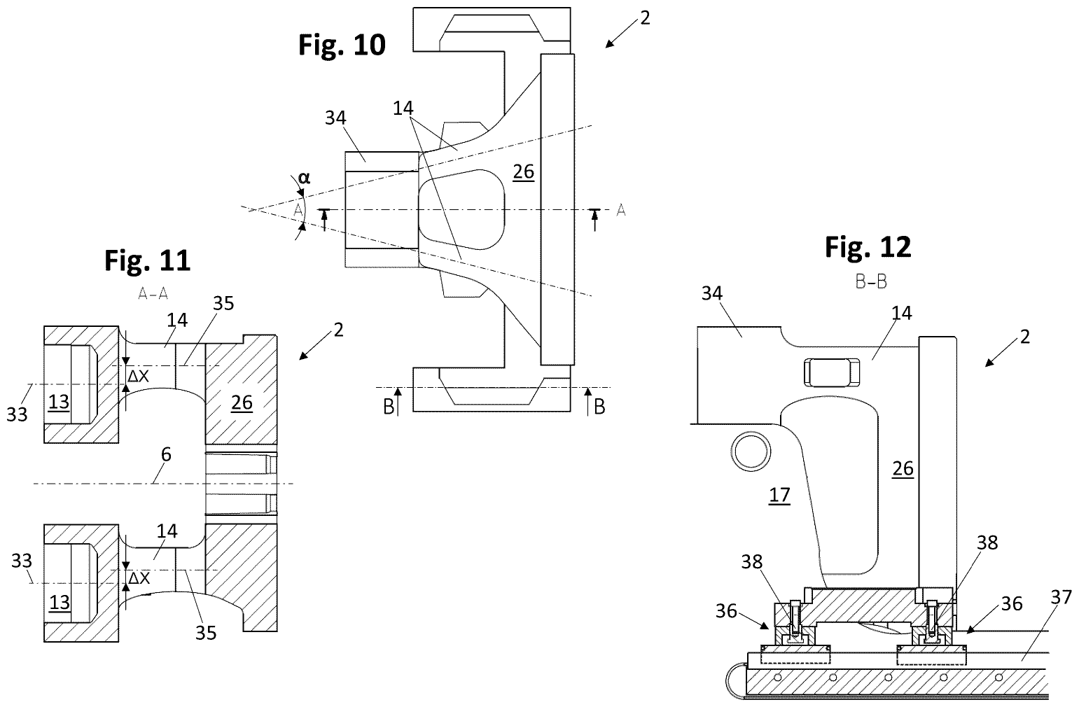

FIG. 10 shows a plan view of the exemplary embodiment of the movable mold mounting plate 2 from FIGS. 8 and 9.

FIGS. 11 and 12 show the sections marked in FIG. 10, with FIG. 11 showing section A-A and FIG. 12 showing section B-B.

This embodiment of the movable mold mounting plate 2 is designed as a machine element for mounting a mold comprises a plate-shaped base body 26. This plate-shaped base body 26 is connected to the pressure pad elements 34 via the struts 14. The pressure pad elements 34 in this exemplary embodiment are implemented from pressure pad housings which support the cylinder 13 of the hydraulic piston-cylinder unit, which function as pressure pad 11. Each of the two pressure pad elements 34 is connected to the base body 26 of the movable mold mounting plate 2 via two struts 14.

The movable mold mounting plate 2 is formed in one piece with the plate-shaped base body 26, the struts 14 and the pressure pad elements 34. The struts 14 comprise a strut longitudinal axis 35 (see FIG. 10 or 11). The two struts 14, each of which connects a pressure pad element 34 to the base body 26, enclose an angle α with each other.

Furthermore, the longitudinal axis 33 of the pressure pad element 34 has a strut point offset ΔX to the strut longitudinal axes 35 of the struts 14 (see FIG. 11). This strut point offset ΔX is deflected in the same direction for the two pressure pad elements 34.

Furthermore, the struts 14 are symmetrical in a view transverse to the strut longitudinal axis 35 (see FIG. 11), wherein each of the struts 14 has a first contour which is substantially straight and a second contour which is curved, more precisely, has an ellipsoidal curvature.

Furthermore, it can be seen in FIG. 11 that the struts 14 with their strut longitudinal axes 35 are arranged asymmetrically to the central longitudinal axis 6. By means of a corresponding arrangement, for example, ideally taking into account the deformations, a parallelism of the mold mounting plates (in particular the mounting surfaces 23 of the movable mold mounting plate 2 relative to the fixed mold mounting plate 3) can be achieved during a closing force build-up and an opening of the mold can be counteracted.

Ideally, in this exemplary embodiment, one of the strut longitudinal axes 35, in particular the strut longitudinal axes 35 of the strut 14 further away from the machine frame 17, has a distance from the central longitudinal axis 6 that is greater by a value between 1% and 10%, preferably between 2.5% and 7.5%, particularly preferably 5%.

All these measures of offsetting the curvatures and straightness are selected accordingly in order to convert deformations of the closing unit, or more precisely of the machine frame 17 and the movable mold mounting plate 2, as far as possible into elastic deformations of the struts 14, so that plate parallelism and mold closure are not influenced or are influenced only to a small extent.

As can be seen from FIG. 12, the movable mold mounting plate 2 comprises two guide shoes 36 on each side, which are offset from one another along the longitudinal axis 6. These guide shoes 36 are guided on the guide rail 37, which guide rail 37 is in turn connected to the machine frame 17 of the closing unit 1. When a closing force is now built up, the C-shaped machine frame 17 is deformed, which also deforms the guide rails 37. As a result, the movable mold mounting plate 2 is lifted in the front and partially in the rear region.

The guide shoes 36 are connected to the movable mold mounting plate 2 via guide bolts 38. These guide bolts 38 allow a translational movement between the guide shoe 36 and the movable mold mounting plate 2, whereby when the movable mold mounting plate 2 is lifted, no damage to the guide shoes 36 or the guide rail 37 occurs, while nevertheless ensuring that the movable mold mounting plate 2 is secured in position relative to the guide shoes 36.

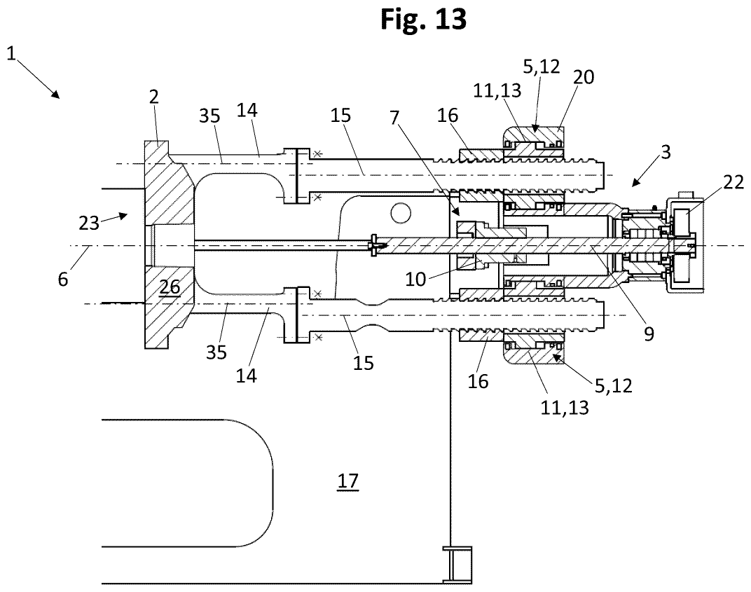

FIG. 13 shows a further embodiment variant of a closing unit 1, which, compared to FIG. 1, comprises a “reverse” arrangement of the closing force mechanism 5 comprising the push rods 15, the locking nuts 16 and the pressure pads 11. In this exemplary embodiment of FIG. 13, the push rods 15 are directly coupled to the struts 14 by a screw connection. The locking nuts 16 cooperating with the push rods 15 are connected to the support plate 20 via the closing force mechanism 5. In this exemplary embodiment, the support plate is also screwed to the machine frame 17.

The pressure pads 11 of the closing force mechanism 5 are arranged within corresponding bores of the carrier plate 20 and are designed to build up a relative movement and/or a closing force between the carrier plate 20 and the locking nuts 16 in order to build up the closing force, which relative movement and/or closing force is/will in turn be passed on to the movable mold mounting plate 2 via the push rods 15. The pressure pads 11 are implemented as a piston-cylinder unit 12, wherein the cylinder 13 of these piston-cylinder units 12 is formed by the support plate 20 (in particular corresponding recesses of the support plate 20).

The remaining components of the exemplary embodiment of FIG. 13 essentially correspond to those of the exemplary embodiment of FIG. 1.

### LIST OF REFERENCE NUMERALS

1 closing unit
2 movable mold mounting plate
3 fast-stroke device
4 fixed mold mounting plate
5 closing force mechanism
6 central longitudinal axis
7 spindle drive
8 axis of rotation
9 spindle
10 recirculating ball nut
11 pressure pad
12 piston-cylinder unit
13 cylinder
14 strut
15 push rod
16 locking nut
17 machine frame of the closing unit
18 sliding guide of the movable mold mounting plate
19 mold
20 support plate
21 electric drive unit
22 gear
23 mounting surface
24 link rod
25 link bridge
26 base body
27 yoke
28 ejector drive
29 fast-stroke element
30 connecting rods
31 ejector plate
32 ejector columns
33 longitudinal axis of the pressure pads
34 pressure pad element
35 strut longitudinal axis
36 guide shoe
37 guide rail
38 guide bolt
α angle
ΔX strut point offset

1. A machine element for mounting a mold, in particular a mold mounting plate, for a tie-bar-less closing unit of a molding machine, comprising:
a plate-shaped base body, and
at least two pressure pad elements each being part of a hydraulic actuator, preferably a pressure pad, and having a longitudinal axis,
wherein:
the at least two pressure pad elements are offset transversely from one another with respect to at least one of the longitudinal axes, and
for the at least two pressure pad elements, at least one respective strut is provided, which connects the respective pressure pad element to the base body.

2. The machine element according to claim 1, wherein at least two, preferably all, of the following are designed as a single piece, preferably as a cast part:
the plate-shaped base body,
the at least one strut, and
at least one of the at least two pressure pad elements.

3. The machine element according to claim 1, wherein the at least one strut has a strut longitudinal axis and a first point at which the strut longitudinal axis meets the base body is different from a second point at which the longitudinal axis of the corresponding pressure pad element meets the base body.

4. The machine element according to claim 3, wherein an imaginary offset axis exists between the at least two pressure pad elements and the first point has a strut point offset from the second point along the offset axis.

5. The machine element according to claim 4, wherein the strut point offset in the at least two pressure pad elements points in the same direction.

6. The machine element according to claim 1, wherein at least two respective struts are provided per pressure pad element, preferably wherein the at least two struts enclose an angle with one another.

7. The machine element according to claim 1, wherein the at least two pressure pad elements are designed at least as part of a hydraulic piston-cylinder unit, preferably as a pressure pad housing and/or cylinder.

8. The machine element according to claim 7, wherein the at least two pressure pad housings have a different inner diameter.

9. The machine element according to claim 1, wherein the struts are asymmetrical when viewed transversely to the strut longitudinal axis, preferably wherein a first contour of the struts is substantially straight and/or a second contour of the struts is curved.

10. The machine element according to claim 1, wherein at least two guide shoes are provided which are offset from one another along the longitudinal axis.

11. A tie-bar-less molding machine, in particular an injection molding machine, with the machine element according to claim 1.

12. The molding machine according to claim 11, further comprising a control or regulation unit configured to control the hydraulic actuators associated with the at least two pressure pad elements for applying different forces to the machine element, in particular by applying different hydraulic pressures.

13. The molding machine according to claim 11, further comprising at least two push rods lockable relative to a machine frame and configured to cooperate with the hydraulic actuators.

14. The molding machine according to claim 13, wherein the at least two push rods have different diameters.

15. The molding machine according to claim 13, wherein the at least two push rods—with the exception of the attachment to the hydraulic actuators—are released from the rest of the forming machine.

16. The molding machine according to claim 12, further comprising at least two guides preferably offset from one another along the longitudinal axis, wherein the guides are designed such that a lifting of the machine element from a guide rail is possible.
